(19) United States
(12) Patent Application Publication
(10) Pub. No.: US 2025/0098040 A1
(43) Pub. Date: Mar. 20, 2025

(54) MICROWAVE OVEN HOOD VENT COMBINATION APPLIANCE

(71) Applicant: WHIRLPOOL CORPORATION, BENTON HARBOR, MI (US)

(72) Inventors: Youcheng Huang, Shenzhen (CN); Xiangxu Liu, Shenzhen (CN)

(73) Assignee: WHIRLPOOL CORPORATION, BENTON HARBOR, MI (US)

(21) Appl. No.: 18/729,336

(22) PCT Filed: Jan. 18, 2022
(86) PCT No.: PCT/CN2022/072447

§ 371 Date: Jul. 16, 2024

(51) Int. Cl. H05B 6/64

(52) U.S. Cl. CPC H05B 6/6423; H05B 6/6455

(57) ABSTRACT

A microwave oven hood vent combination appliance includes top, bottom, first lateral, second lateral, rear, and front sides, a cooking cavity, a door, an infrared module, and a hood vent fan assembly. The fan assembly includes a first centrifugal fan having a first centrifugal fan outboard inlet and a first centrifugal fan inboard inlet, a second centrifugal fan having a second centrifugal fan outboard inlet and a second centrifugal fan inboard inlet, and a hood vent fan assembly motor which drives the first and second centrifugal fans. The first centrifugal fan delivers air along a first ventilation air flow path, the second centrifugal fan delivers air along a second ventilation air flow path, and the first centrifugal fan delivers air along a cooling air flow path.

### CROSS-REFERENCE TO RELATED APPLICATIONS

This application is a U.S. national stage application under 35 U.S.C. § 371 that claims the benefit of priority under 35 U.S.C. § 365 of International Patent Application No. PCT/CN2022/072447, filed on Jan. 18, 2022, designating the United States of America, the contents of which are relied upon and incorporated herein by reference in their entirety.

### BACKGROUND OF THE DISCLOSURE

The present disclosure generally relates to a microwave oven hood vent combination appliance and, more specifically, to a microwave oven hood vent combination appliance that includes a hood vent fan assembly for delivering cooling air to an infrared module of the appliance.

### SUMMARY OF THE DISCLOSURE

According to one aspect of the present disclosure, a microwave oven hood vent combination appliance includes a top side opposite a bottom side, a first lateral side between the top and bottom sides and opposite a second lateral side, a rear side opposite a front side, between the top and bottom sides, and between the first and second lateral sides, a cooking cavity positioned between the top and bottom sides and accessible via an access opening at the front side that is selectively covered by a door, an infrared module positioned between the cooking cavity and the top side and configured to emit infrared waves to detect a temperature of food within the cooking cavity, and a hood vent fan assembly proximate to the top side and the rear side. The fan assembly includes a first centrifugal fan having a first centrifugal fan outboard inlet that faces toward the first lateral side and a first centrifugal fan inboard inlet that faces toward the second lateral side. The first centrifugal fan delivers air along a first ventilation air flow path through a first ventilation air flow path inlet at the bottom side, between the first lateral side and the cooking cavity, into the first centrifugal fan outboard inlet, and out of a first hood vent fan assembly outlet. The fan assembly also includes a second centrifugal fan having a second centrifugal fan outboard inlet that faces toward the second lateral side and a second centrifugal fan inboard inlet that faces toward the first lateral side. The second centrifugal fan delivers air along a second ventilation air flow path through a second ventilation air flow path inlet at the bottom side, between the second lateral side and the cooking cavity, into the second centrifugal fan outboard inlet, and out of a second hood vent fan assembly outlet. The fan assembly further includes a hood vent fan assembly motor coupled to and positioned between the first and second centrifugal fans. The hood vent fan assembly motor drives the first and second centrifugal fans. The first centrifugal fan further delivers air along a cooling air flow path through a cooling air flow path inlet that is proximate to the top and front sides, such that the front side is nearer than the rear side to the cooling air flow path inlet and the top side is nearer than the bottom side to the cooling air flow path inlet, past the infrared module, such that heat from the infrared module is transferred to the air, past the hood vent fan assembly motor, such that heat is transferred from the motor to the air, into the first centrifugal fan inboard inlet, and out of the first hood vent fan assembly outlet.

According to another aspect of the present disclosure, a microwave oven hood vent combination appliance includes a cooking cavity, an infrared module positioned above the cooking cavity and configured to emit infrared waves to detect a temperature of food within the cooking cavity, and a hood vent fan assembly upward of the cooking cavity and including a hood vent fan assembly motor and a fan. The fan delivers air along a ventilation air flow path through a ventilation air flow path inlet downward of the cooking cavity and out of a hood vent fan assembly outlet that is upward of the cooking cavity. Further, the fan delivers air along a cooling air flow path through a cooling air flow path inlet upward of the cooking cavity, past the infrared module, such that heat from the infrared module is transferred to the air, past the hood vent fan assembly motor, and out of the hood vent fan assembly outlet.

According to yet another aspect of the present disclosure, a microwave oven hood vent combination appliance includes a cooking cavity, an infrared module proximate to the cooking cavity and configured to emit infrared waves to detect a temperature of food within the cooking cavity, and a hood vent fan assembly upward of the cooking cavity and including a hood vent fan assembly motor and a fan. The fan delivers air along a cooling air flow path by drawing air into a cooling air flow path inlet upward of the cooking cavity, past the infrared module such that heat from the infrared module is transferred to the air, and expels the air out of a hood vent fan assembly outlet.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a front elevational view of a microwave oven hood vent combination appliance, according to the present disclosure;

FIG. 2 is a front elevational view of the appliance of FIG. 1, illustrating a door of the appliance in an open position, according to the present disclosure;

FIG. 3 is a top perspective view of a microwave oven hood vent combination appliance, illustrating a vent grid assembly with a vent grid assembly shutter in an open position, according to the present disclosure;

FIG. 4 is a bottom perspective view of a microwave oven hood vent combination appliance, illustrating the vent grid assembly shutter in a closed position, according to the present disclosure;

FIG. 5 is a top perspective view of a portion of a microwave oven hood vent combination appliance, illustrating a cooling air flow path, according to the present disclosure;

FIG. 6 is a bottom elevational cross-sectional view of the microwave oven hood vent combination appliance of FIG. 1 taken through line VI-VI, illustrating a cooling air flow path, according to the present disclosure;

FIG. 7 is a cross-sectional view of the microwave oven hood vent combination appliance of FIG. 1 taken through line VII-VII, illustrating a cooling air flow path along which air is delivered past an infrared module of the appliance, according to the present disclosure;

FIG. 8 is a top perspective view of a base plate of a microwave oven hood vent combination appliance, illustrating an aperture defined by the base plate, according to the present disclosure; and

FIG. 9 is a bottom perspective view of a base plate, illustrating an aperture defined by the base plate, according to the present disclosure.

The components in the figures are not necessarily to scale, emphasis instead being placed upon illustrating the principles described herein.

### DETAILED DESCRIPTION

The present illustrated embodiments reside primarily in combinations of apparatus components related to a microwave oven hood vent combination appliance. Accordingly, the apparatus components have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

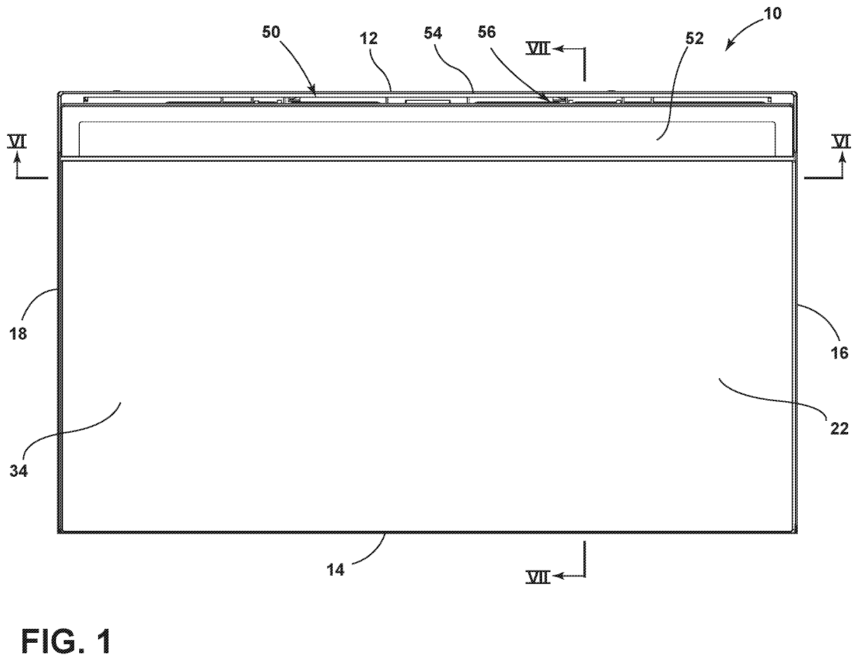

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises a . . . ” does not, without more constraints, preclude the existence of additional identical elements in the process, method, article, or apparatus that comprises the element.

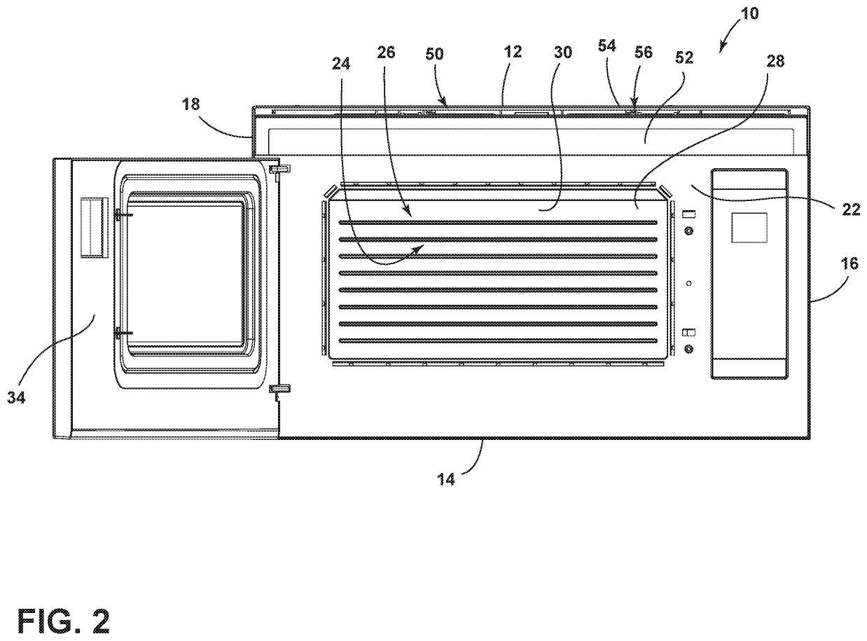

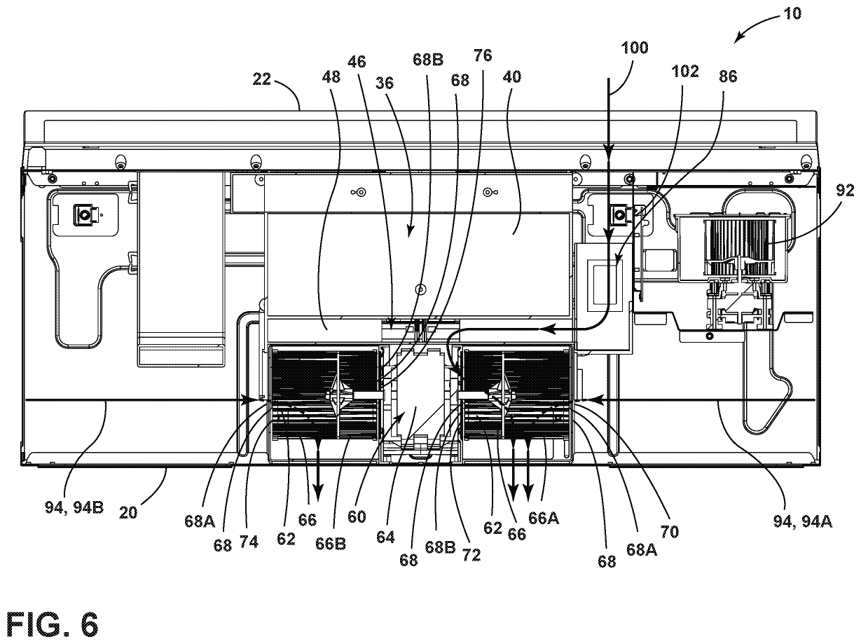

Referring to FIGS. 1-9, reference numeral 10 generally designates a microwave oven hood vent combination appliance. The appliance 10 includes a top side 12, a bottom side 14 opposite the top side 12, a first lateral side 16 that is between the top and bottom sides 12, 14, and a second lateral side 18 that is opposite the first lateral side 16. In the embodiment illustrated in FIG. 1, the first lateral side 16 is the right side and the second lateral side 18 is the left side. In some implementations, the first lateral side 16 can be the left side and the second lateral side 18 can be the right side. The appliance 10 includes a rear side 20 that is positioned between the top and bottom sides 12, 14 and between the first and second lateral sides 16, 18. The appliance 10 further includes a front side 22 that is opposite the rear side 20. A cooking cavity 24 is positioned between the top and bottom sides 12, 14 of the appliance 10 and is accessible via an access opening 26 disposed at the front side 22 of the appliance 10. The cooking cavity 24 can be defined by a shell 28 of the appliance 10, as illustrated in FIG. 2. The shell 28 has an interior surface 30 that defines the cooking cavity 24 and an exterior surface 32 opposite the interior surface 30. In some implementations, the shell 28 can be an assembly of a plurality of components. It is contemplated that the shell 28 may be a singular component, in some embodiments.

As illustrated in FIGS. 1 and 2, the appliance 10 includes a door 34. The door 34 is operable to selectively cover the access opening 26. The door 34 is operable between a closed position, as illustrated in FIG. 1, wherein the door 34 covers the access opening 26, and an open position, as illustrated in FIG. 2, wherein access to the access opening 26 is provided.

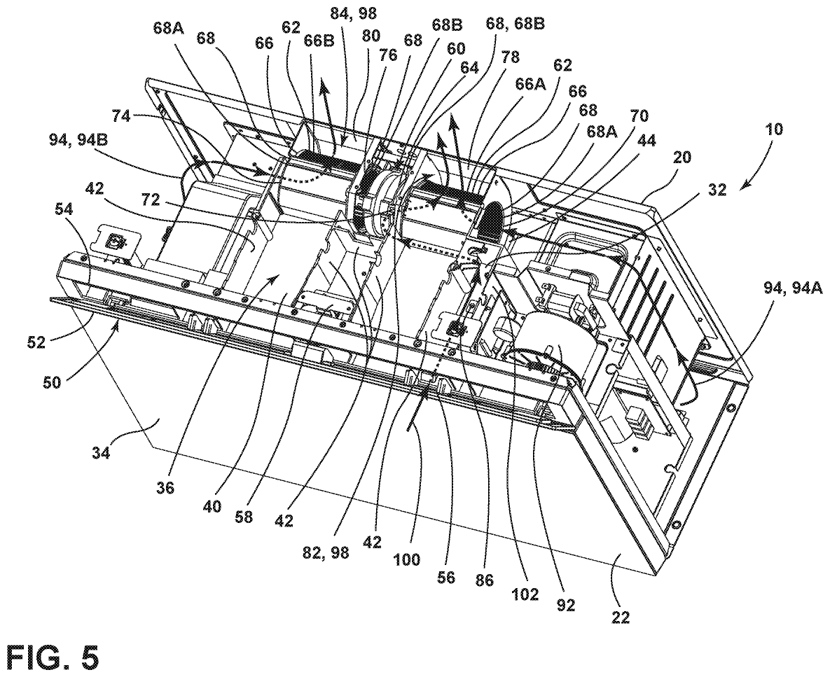

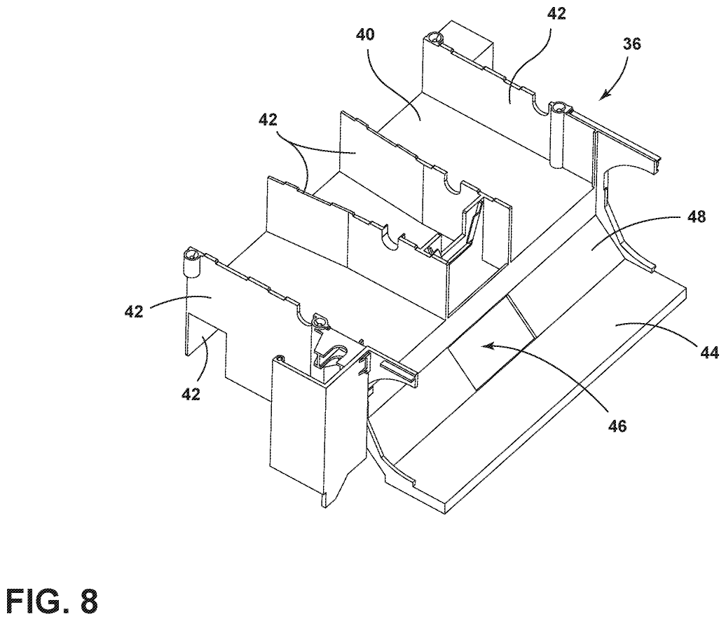

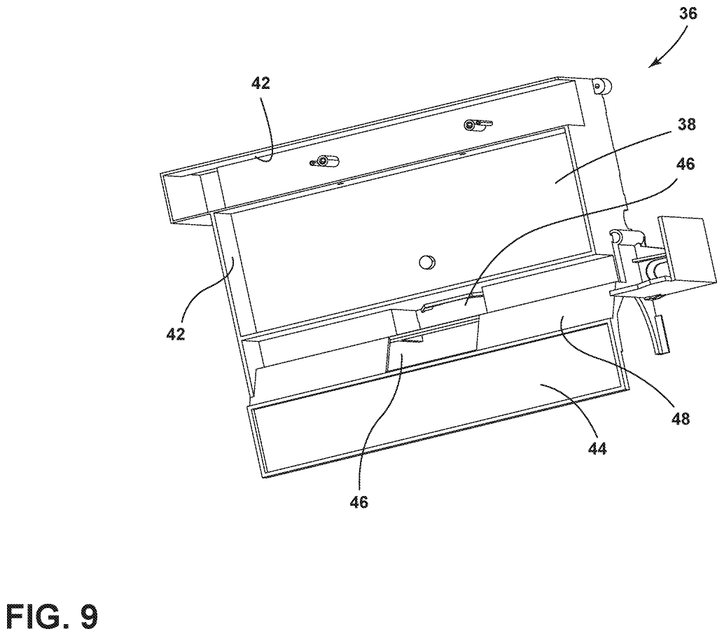

Referring now to FIGS. 5-9, the appliance 10 includes a base plate 36. The base plate 36 is positioned above (i.e., directly upward of) the cooking cavity 24. In some embodiments, the base plate 36 is coupled to the exterior surface 32 of the shell 28 of the appliance 10. The base plate 36 includes an underside 38 that faces generally downward and an upper side 40 that is opposite the underside 38. The base plate 36 can include one or more baffles 42 that extend outward from the upper side 40 and/or the underside 38 of the base plate 36, as illustrated in FIGS. 8 and 9. In the embodiment illustrated in FIG. 8, the base plate 36 includes a lower platform 44. The lower platform 44 of the base plate 36 may be positioned proximate to the rear side 20 of the appliance 10. In some implementations, the lower platform 44 of the base plate 36 may be the portion of the base plate 36 that is nearest to the rear side 20 of the appliance 10.

The base plate 36 defines an aperture 46. In some implementations, the aperture 46 is proximate to and/or partially defined by the lower platform 44 of the base plate 36. As illustrated in FIG. 8, the aperture 46 is defined by an angled portion 48 of the base plate 36 that extends upward and toward the front side 22 of the appliance 10 from the lower platform 44. The base plate 36 may be configured as an air guide that defines one or more air flow paths, as described further herein.

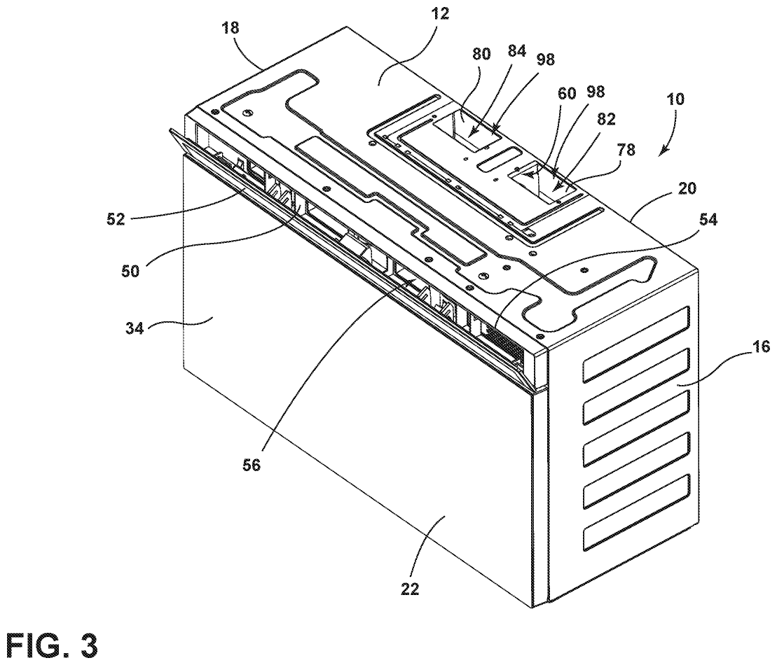

Referring now to FIGS. 3-5, the appliance 10 can include a vent grid assembly 50. The vent grid assembly 50 includes a vent grid assembly shutter 52. The vent grid assembly shutter 52 is positioned upward of the cooking cavity 24. In various implementations, the vent grid assembly shutter 52 can be positioned proximate to the top and front sides 12, 22 of the appliance 10. For example, the vent grid assembly shutter 52 may be positioned at a top front corner 54 of the appliance 10 where the front side 22 and the top side 12 of the appliance 10 intersect. As illustrated in FIG. 3, the vent grid assembly shutter 52 of the vent grid assembly 50 is positioned above the door 34 of the appliance 10 in the closed position of the door 34.

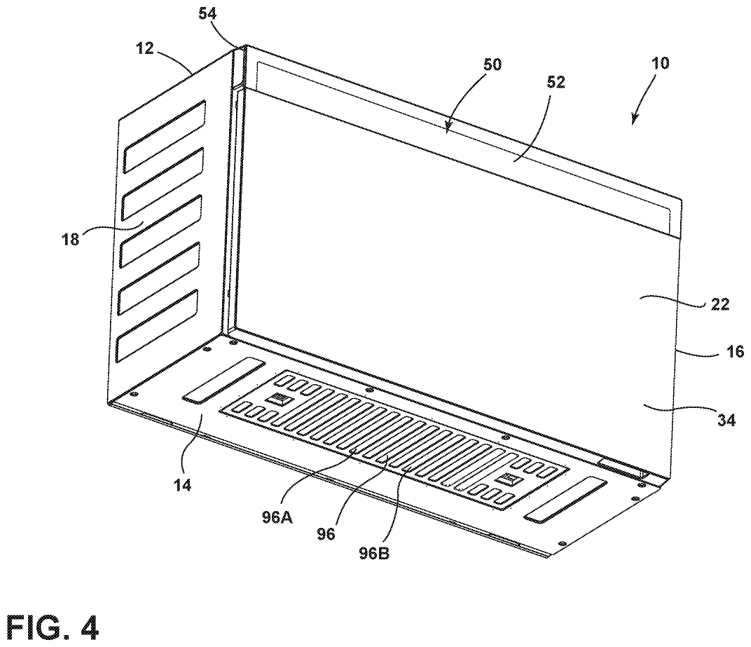

In various implementations, the vent grid assembly shutter 52 is movable between open and closed positions. For example, in the embodiment illustrated in FIGS. 3 and 4, the vent grid assembly shutter 52 is pivotable between an open position, as illustrated in FIG. 3, and a closed position, as illustrated in FIG. 4. As described further herein, movement of the vent grid assembly shutter 52 to the open position may reveal a cooling air flow path inlet 56 of the appliance 10, and movement of the vent grid assembly shutter 52 to the closed position may cover the cooling air flow path inlet 56. The vent grid assembly 50 includes a vent grid assembly motor 58 that is configured to propel movement of the vent grid assembly shutter 52 between the open and closed positions. The vent grid assembly motor 58 can be mounted to the base plate 36. In the embodiment illustrated in FIG. 5, the vent grid assembly motor 58 is coupled to and supported by the upper side 40 of the base plate 36.

Referring now to FIGS. 3 and 5-7, the appliance 10 includes a hood vent fan assembly 60. The hood vent fan assembly 60 can be positioned proximate to the top side 12 and the rear side 20 of the appliance 10, as illustrated in FIG. 5. In some implementations, the top side 12 is nearer than the bottom side 14 to the hood vent fan assembly 60, and the rear side 20 is nearer than the front side 22 to the hood vent fan assembly 60. As illustrated in FIG. 5, the hood vent fan assembly 60 can be coupled to the base plate 36. In various implementations, the hood vent fan assembly 60 is coupled to the upper side 40 of the base plate 36. In the embodiment illustrated in FIG. 5, the hood vent fan assembly 60 is coupled to the upper side 40 of the lower platform 44 of the base plate 36 proximate to the aperture 46 defined by the base plate 36.

The hood vent fan assembly 60 includes a fan 62 and a hood vent fan assembly motor 64 that is operably coupled to and configured to drive the fan 62. A variety of types of fans 62 are contemplated. In various implementations, the fan 62 of the hood vent fan assembly 60 is a centrifugal fan 66. The centrifugal fan 66 may be configured to draw air into the centrifugal fan 66 in a first direction and expel air from the centrifugal fan 66 in a second direction that is generally perpendicular to the first direction. The centrifugal fan 66 may include a plurality of inlets 68 into which the centrifugal fan 66 is configured to draw air. For example, the centrifugal fan 66 may include a first inlet 68A and a second inlet 68B. Air may be drawn into the first inlet 68A in a first direction and the second inlet 68B in a second direction, wherein the first and second directions are generally opposite of each other.

In some implementations, the hood vent fan assembly 60 of the appliance 10 may include a plurality of fans 62. For example, the hood vent fan assembly 60 can include a first centrifugal fan 66A and a second centrifugal fan 66B. The first and second centrifugal fans 66A, 66B can be driven by corresponding first and second hood vent fan assembly motors 64, in some embodiments. Alternatively, the first and second centrifugal fans 66A, 66B can be driven by a single hood vent fan assembly motor 64, as illustrated in FIG. 5. In the embodiment illustrated in FIG. 5, the hood vent fan assembly 60 includes a first centrifugal fan 66A having a first centrifugal fan outboard inlet 70 that faces toward the first lateral side 16 of the appliance 10 and a first centrifugal fan inboard inlet 72 that faces toward the second lateral side 18 of the appliance 10. The hood vent fan assembly 60 further includes a second centrifugal fan 66B having a second centrifugal fan outboard inlet 74 that faces toward the second lateral side 18 and a second centrifugal fan inboard inlet 76 that faces toward the first lateral side 16. The hood vent fan assembly 60 illustrated in FIG. 5 further includes the hood vent fan assembly motor 64 which is coupled to and positioned between the first and second centrifugal fans 66A, 66B. The hood vent fan assembly motor 64 drives the first and second centrifugal fans 66A, 66B. As illustrated, the hood vent fan assembly 60 includes first and second fan housings 78, 80 that define first and second hood vent fan assembly outlets 82, 84.

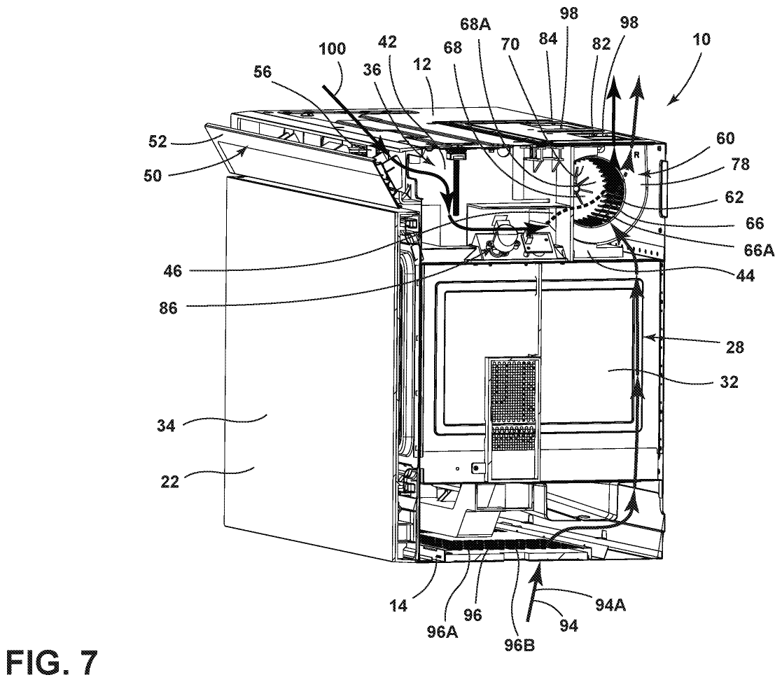

Referring now to FIG. 7, the appliance 10 includes an infrared module 86. In some implementations, the infrared module 86 is positioned between the cooking cavity 24 and the top side 12 of the appliance 10 and is configured to emit infrared waves to detect a temperature of food within the cooking cavity 24. As illustrated in FIG. 7, the infrared module 86 may be positioned adjacent to the base plate 36 of the appliance 10. The appliance 10 may further include a variety of other electrical components, such as a transformer, and a magnetron. Further, as illustrated in FIG. 5, the appliance 10 can include an auxiliary fan 92 that is configured to deliver air to various electronic components of the appliance 10, such as the magnetron and the transformer, to cool the electronic components.

Referring now to FIGS. 5-7, the appliance 10 may include a plurality of air flow paths along which air is configured to be delivered via the at least one fan 62 of the hood vent fan assembly 60. In some implementations, the fan 62 of the hood vent fan assembly 60 is configured to deliver air along at least one ventilation air flow path 94. In operation, the ventilation air flow path 94 provides an avenue for hot air that is heated by a range (not shown) beneath the appliance 10 to be delivered through the appliance 10 and out of a hood vent fan assembly outlet 98. In one implementation, the fan 62 of the hood vent fan assembly 60 delivers air along the ventilation air flow path 94 through a ventilation air flow path inlet 96 that is positioned downward of the cooking cavity 24, as illustrated in FIG. 7, and out of the hood vent fan assembly outlet 98 that is positioned upward of the cooking cavity 24.

In the embodiment illustrated in FIG. 5, wherein the hood vent fan assembly 60 includes the first and second centrifugal fans 66A, 66B and the hood vent fan assembly motor 64 positioned between the first and second centrifugal fans 66A, 66B, the appliance 10 includes first and second ventilation air flow paths 94A, 94B. The first centrifugal fan 66A delivers air along the first ventilation air flow path 94A through a first ventilation air flow path inlet 96A at the bottom side 14 of the appliance 10, between the first lateral side 16 and the cooking cavity 24, into the first centrifugal fan outboard inlet 70, and out of the first hood vent fan assembly outlet 82, which is defined by the first fan housing 78 of the hood vent fan assembly 60. The second centrifugal fan 66B delivers air along the second ventilation air flow path 94B through a second ventilation air flow path inlet 96B at the bottom side 14 of the appliance 10, between the second lateral side 18 and the cooking cavity 24, into the second centrifugal fan outboard inlet 74, and out of the second hood vent fan assembly outlet 84, which is defined by the second fan housing 80 of the hood vent fan assembly 60. As illustrated in FIG. 3, the first and second fan housings 78, 80 of the hood vent fan assembly 60 extend to the top side 12 of the appliance 10, such that the air flows out of the first and second hood vent fan assembly outlets 82, 84 through the top side 12 of the appliance 10.

The hood vent fan assembly 60 is also configured to deliver air along a cooling air flow path 100 defined by the appliance 10. The cooling air flow path 100 includes the cooling air flow path inlet 56. The cooling air flow path inlet 56 can be positioned proximate to the top side 12 of the appliance 10 and the front side 22 of the appliance 10. In some implementations, the front side 22 of the appliance 10 is nearer than the rear side 20 of the appliance 10 to the cooling air flow path inlet 56 and the top side 12 of the appliance 10 is nearer than the bottom side 14 of the appliance 10 to the cooling air flow path inlet 56. As illustrated in FIGS. 5-7, the vent grid assembly shutter 52 provides access to the cooling air flow path inlet 56 of the appliance 10 in the open position of the vent grid assembly shutter 52.

In some implementations, the fan 62 of the hood vent fan assembly 60 delivers air along a cooling air flow path 100 by drawing air into the cooling air flow path inlet 56, which is upward of the cooking cavity 24, and past the infrared module 86, such that heat from the infrared module 86 is transferred to the air. Further, the fan 62 expels the air out of the hood vent fan assembly outlet 98. In some implementations, the fan 62 delivers the air past the infrared module 86 and then, subsequently, past the hood vent fan assembly motor 64 to cool the hood vent fan assembly motor 64. In some implementations, where the fan 62 is the centrifugal fan 66 that includes the first inlet 68A and the second inlet 68B that is nearer than the first inlet 68A to the hood vent fan assembly motor 64, the centrifugal fan 66 delivers air into the first inlet 68A along the ventilation air flow path 94 and into the second inlet 68B along the cooling air flow path 100. In some implementations, air that is delivered along the cooling air flow path 100 travels through the cooling air flow path inlet 56, past the infrared module 86, beneath a portion of the underside 38 of the base plate 36, generally upward through the aperture 46 defined by the base plate 36, past the hood vent fan assembly motor 64, and ultimately out of the hood vent fan assembly outlet 98, as illustrated in FIG. 7.

In various implementations, a portion of the cooling air flow path 100 is defined by the exterior surface 32 of the shell 28 of the appliance 10 and the base plate 36 of the appliance 10. In some implementations, a portion of the cooling air flow path 100 is defined by the exterior surface 32 of the shell 28 and the underside 38 of the base plate 36 of the appliance 10. As illustrated in FIG. 7, the infrared module 86 is lower than the cooling air flow path inlet 56 and is lower than the hood vent fan assembly outlet 98. In other words, the infrared module 86 is nearer than both the cooling air flow path inlet 56 and the hood vent fan assembly outlet 98 to the bottom side 14 of the appliance 10.

Referring now to FIGS. 5-7, in an exemplary embodiment of the appliance 10, the appliance 10 includes the hood vent fan assembly 60 that is coupled to the upper side 40 of the lower platform 44 of the base plate 36. The hood vent fan assembly 60 includes the first centrifugal fan 66A that includes the first centrifugal fan outboard inlet 70 that faces toward the first lateral side 16 and the first centrifugal fan inboard inlet 72 that faces toward the second lateral side 18. The hood vent fan assembly 60 further includes the second centrifugal fan 66B having the second centrifugal fan outboard inlet 74 that faces toward the second lateral side 18 and the second centrifugal fan inboard inlet 76 that faces toward the first lateral side 16. The hood vent fan assembly 60 further includes the hood vent fan assembly motor 64 that is coupled to and positioned between the first and second centrifugal fans 66A, 66B.

In operation of the exemplary embodiment, the first centrifugal fan 66A delivers air along the first ventilation air flow path 94A through the first ventilation air flow path inlet 96A disposed at the bottom side 14 of the appliance 10, between the first lateral side 16 and the cooking cavity 24, into the first centrifugal fan outboard inlet 70, and out of the first hood vent fan assembly outlet 82. The second centrifugal fan 66B delivers air along the second ventilation air flow path 94B through the second ventilation air flow path inlet 96B at the bottom side 14 of the appliance 10, between the second lateral side 18 of the cooking cavity 24, into the second centrifugal fan outboard inlet 74, and out of the second hood vent fan assembly outlet 84.

The first centrifugal fan 66A further delivers air along the cooling air flow path 100. Air delivered along the cooling air flow path 100 enters through the cooling air flow path inlet 56 that is proximate to the top and front sides 12, 22 of the appliance 10, flows past the infrared module 86, such that heat from the infrared module 86 is transferred to the air, flows beneath a portion of the underside 38 of the base plate 36, flows generally upward through the aperture 46 that is defined by the base plate 36 and disposed laterally between the first and second centrifugal fans 66A, 66B, flows past the hood vent fan assembly motor 64, such that heat is transferred from the hood vent fan assembly motor 64 to the air, flows into the first centrifugal fan inboard inlet 72, and ultimately flows out of the first hood vent fan assembly outlet 82.

In various implementations, the second centrifugal fan 66B can additionally or alternatively deliver air along the cooling air flow path 100. For example, air can be delivered along the cooling air flow path 100 by the second centrifugal fan 66B, such that it enters through the cooling air flow path inlet 56, flows past the infrared module 86, flows beneath a portion of the underside 38 of the base plate 36, flows generally upward through the aperture 46 that is defined by the base plate 36, flows past the hood vent fan assembly motor 64, flows into the second centrifugal fan inboard inlet 76, and ultimately flows out of the second hood vent fan assembly outlet 84.

As illustrated in FIG. 7, in various implementations, the infrared module 86 can be generally separated from other electrical components of the appliance 10 that are cooled by auxiliary fan 92, such as the magnetron and/or the transformer, by a partition 102. As such, the partition 102 can prevent the infrared module 86 from being sufficiently cooled by the auxiliary fan 92 along with the other electrical components. The appliance 10 of the present disclosure may advantageously allow the hood vent fan assembly 60 to serve the dual purpose of drawing hot air from beneath the appliance 10 through the ventilation air flow path 94 and drawing cool air through the cooling air flow path 100 to cool the infrared module 86. This functionality may negate the need for an additional auxiliary fan 92 that is dedicated to cooling the infrared module 86, which may reduce the cost of manufacturing the appliance 10.

According to one aspect of the present disclosure, a microwave oven hood vent combination appliance includes a top side opposite a bottom side, a first lateral side between the top and bottom sides and opposite a second lateral side, a rear side opposite a front side, between the top and bottom sides, and between the first and second lateral sides, a cooking cavity positioned between the top and bottom sides and accessible via an access opening at the front side that is selectively covered by a door, an infrared module positioned between the cooking cavity and the top side and configured to emit infrared waves to detect a temperature of food within the cooking cavity, and a hood vent fan assembly proximate to the top side and the rear side. The fan assembly includes a first centrifugal fan having a first centrifugal fan outboard inlet that faces toward the first lateral side and a first centrifugal fan inboard inlet that faces toward the second lateral side. The first centrifugal fan delivers air along a first ventilation air flow path through a first ventilation air flow path inlet at the bottom side, between the first lateral side and the cooking cavity, into the first centrifugal fan outboard inlet, and out of a first hood vent fan assembly outlet. The fan assembly also includes a second centrifugal fan having a second centrifugal fan outboard inlet that faces toward the second lateral side and a second centrifugal fan inboard inlet that faces toward the first lateral side. The second centrifugal fan delivers air along a second ventilation air flow path through a second ventilation air flow path inlet at the bottom side, between the second lateral side and the cooking cavity, into the second centrifugal fan outboard inlet, and out of a second hood vent fan assembly outlet. The fan assembly further includes a hood vent fan assembly motor coupled to and positioned between the first and second centrifugal fans. The hood vent fan assembly motor drives the first and second centrifugal fans. The first centrifugal fan further delivers air along a cooling air flow path through a cooling air flow path inlet that is proximate to the top and front sides, such that the front side is nearer than the rear side to the cooling air flow path inlet and the top side is nearer than the bottom side to the cooling air flow path inlet, past the infrared module, such that heat from the infrared module is transferred to the air, past the hood vent fan assembly motor, such that heat is transferred from the motor to the air, into the first centrifugal fan inboard inlet, and out of the first hood vent fan assembly outlet.

According to another aspect of the present disclosure, the appliance further includes a base plate positioned above the cooking cavity and having an underside that faces generally downward and an upper side opposite the underside, wherein air delivered along the cooling air flow path travels through the cooling air flow path inlet, past the infrared module, beneath a portion of the underside, generally upward through an aperture defined by the base plate, past the hood vent fan assembly motor, into the first centrifugal fan inboard inlet, and out of the first hood vent fan assembly outlet.

According to another aspect of the present disclosure, the appliance further includes a shell having an interior surface that defines the cooking cavity and an exterior surface opposite the interior surface, wherein a portion of the cooling air flow path is defined by the exterior surface of the shell and the base plate.

According to another aspect of the present disclosure, the appliance further includes a vent grid assembly that includes a vent grid assembly shutter positioned proximate to the top and front sides and movable between an open position, wherein the cooling air flow path inlet is revealed, and a closed position.

According to another aspect of the present disclosure, the vent grid assembly further includes a vent grid assembly motor mounted to the base plate and configured to drive movement of the vent grid assembly shutter between the open and closed positions.

According to another aspect of the present disclosure, the aperture defined by the base plate is positioned laterally-inboard of the first and second centrifugal fans.

According to another aspect of the present disclosure, the hood vent fan assembly is mounted to the upper side of the base plate.

According to another aspect of the present disclosure, the infrared module is positioned lower than the cooling air flow path inlet and the first hood vent fan assembly outlet.

According to another aspect of the present disclosure, a microwave oven hood vent combination appliance includes a cooking cavity, an infrared module positioned above the cooking cavity and configured to emit infrared waves to detect a temperature of food within the cooking cavity, and a hood vent fan assembly upward of the cooking cavity and including a hood vent fan assembly motor and a fan. The fan delivers air along a ventilation air flow path through a ventilation air flow path inlet downward of the cooking cavity and out of a hood vent fan assembly outlet that is upward of the cooking cavity. Further, the fan delivers air along a cooling air flow path through a cooling air flow path inlet upward of the cooking cavity, past the infrared module, such that heat from the infrared module is transferred to the air, past the hood vent fan assembly motor, and out of the hood vent fan assembly outlet.

According to another aspect of the present disclosure, the fan is a centrifugal fan having a first inlet and a second inlet that is nearer than the first inlet to the hood vent fan assembly motor, wherein the centrifugal fan delivers air into the first inlet along the ventilation air flow path and the centrifugal fan delivers air into the second inlet along the cooling air flow path.

According to another aspect of the present disclosure, the appliance further includes a base plate positioned above the cooking cavity and having an underside that faces generally downward and an upper side opposite the underside, wherein air delivered along the cooling air flow path travels through the cooling air flow path inlet, past the infrared module, beneath a portion of the underside, generally upward through an aperture defined by the base plate, past the hood vent fan assembly motor, and out of the hood vent fan assembly outlet.

According to another aspect of the present disclosure, the appliance further includes a shell having an interior surface that defines the cooking cavity and an exterior surface opposite the interior surface, wherein a portion of the cooling air flow path is defined by the exterior surface of the shell and the base plate.

According to another aspect of the present disclosure, the appliance further includes a vent grid assembly that includes a vent grid assembly shutter positioned upward of the cooking cavity and movable between an open position, wherein the cooling air flow path inlet is revealed, and a closed position.

According to another aspect of the present disclosure, the vent grid assembly further includes a vent grid assembly motor mounted to the upper side of the base plate and configured to drive movement of the vent grid assembly shutter between the open and closed positions.

According to another aspect of the present disclosure, the infrared module is positioned lower than the cooling air flow path inlet and the hood vent fan assembly outlet.

According to yet another aspect of the present disclosure, a microwave oven hood vent combination appliance includes a cooking cavity, an infrared module proximate to the cooking cavity and configured to emit infrared waves to detect a temperature of food within the cooking cavity, and a hood vent fan assembly upward of the cooking cavity and including a hood vent fan assembly motor and a fan. The fan delivers air along a cooling air flow path by drawing air into a cooling air flow path inlet upward of the cooking cavity past the infrared module such that heat from the infrared module is transferred to the air, and expelling the air out of a hood vent fan assembly outlet.

According to yet another aspect of the present disclosure, the fan delivers air along a ventilation air flow path through a ventilation air flow path inlet downward of the cooking cavity and out of the hood vent fan assembly outlet that is upward of the cooking cavity.

According to yet another aspect of the present disclosure, the fan is a centrifugal fan having a first inlet and a second inlet that is nearer than the first inlet to the hood vent fan assembly motor, wherein the centrifugal fan delivers air into the first inlet along the ventilation air flow path and the centrifugal fan delivers air into the second inlet along the cooling air flow path.

According to yet another aspect of the present disclosure, the appliance further includes a base plate positioned above the cooking cavity and having an underside that faces generally downward and an upper side opposite the underside, wherein air delivered along the cooling air flow path travels through the cooling air flow path inlet, past the infrared module, beneath a portion of the underside, generally upward through an aperture defined by the base plate, past the hood vent fan assembly motor, and out of the hood vent fan assembly outlet.

According to yet another aspect of the present disclosure, the appliance further includes a shell having an interior surface that defines the cooking cavity and an exterior surface opposite the interior surface, wherein a portion of the cooling air flow path is defined by the exterior surface of the shell and the base plate.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

1. A microwave oven hood vent combination appliance, comprising:
a top side opposite a bottom side;
a first lateral side between the top and bottom sides and opposite a second lateral side;
a rear side opposite a front side, between the top and bottom sides, and between the first and second lateral sides;
a cooking cavity positioned between the top and bottom sides and accessible via an access opening at the front side that is selectively covered by a door;
an infrared module positioned between the cooking cavity and the top side and configured to emit infrared waves to detect a temperature of food within the cooking cavity; and
a hood vent fan assembly proximate to the top side and the rear side, the fan assembly comprising:
a first centrifugal fan having a first centrifugal fan outboard inlet that faces toward the first lateral side and a first centrifugal fan inboard inlet that faces toward the second lateral side, wherein the first centrifugal fan delivers air along a first ventilation air flow path through a first ventilation air flow path inlet at the bottom side, between the first lateral side and the cooking cavity, into the first centrifugal fan outboard inlet, and out of a first hood vent fan assembly outlet;
a second centrifugal fan having a second centrifugal fan outboard inlet that faces toward the second lateral side and a second centrifugal fan inboard inlet that faces toward the first lateral side, wherein the second centrifugal fan delivers air along a second ventilation air flow path through a second ventilation air flow path inlet at the bottom side, between the second lateral side and the cooking cavity, into the second centrifugal fan outboard inlet, and out of a second hood vent fan assembly outlet; and
a hood vent fan assembly motor coupled to and positioned between the first and second centrifugal fans, wherein the hood vent fan assembly motor drives the first and second centrifugal fans, wherein the first centrifugal fan further delivers air along a cooling air flow path through a cooling air flow path inlet that is proximate to the top and front sides, such that the front side is nearer than the rear side to the cooling air flow path inlet and the top side is nearer than the bottom side to the cooling air flow path inlet, past the infrared module, such that heat from the infrared module is transferred to the air, past the hood vent fan assembly motor, such that heat is transferred from the motor to the air, into the first centrifugal fan inboard inlet, and out of the first hood vent fan assembly outlet.

2. The appliance of claim 1, further comprising:
a base plate positioned above the cooking cavity and having an underside that faces generally downward and an upper side opposite the underside, wherein air delivered along the cooling air flow path travels through the cooling air flow path inlet, past the infrared module, beneath a portion of the underside, generally upward through an aperture defined by the base plate, past the hood vent fan assembly motor, into the first centrifugal fan inboard inlet, and out of the first hood vent fan assembly outlet.

3. The appliance of claim 2, further comprising:
a shell having an interior surface that defines the cooking cavity and an exterior surface opposite the interior surface, wherein a portion of the cooling air flow path is defined by the exterior surface of the shell and the base plate.

4. The appliance of claim 2, further comprising:
a vent grid assembly that includes a vent grid assembly shutter positioned proximate to the top and front sides and movable between an open position, wherein the cooling air flow path inlet is revealed, and a closed position.

5. The appliance of claim 4, wherein the vent grid assembly further comprises:
a vent grid assembly motor mounted to the base plate and configured to drive movement of the vent grid assembly shutter between the open and closed positions.

6. The appliance of claim 2, wherein the aperture defined by the base plate is positioned laterally-inboard of the first and second centrifugal fans.

7. The appliance of claim 2, wherein the hood vent fan assembly is mounted to the upper side of the base plate.

8. The appliance of claim 1, wherein the infrared module is positioned lower than the cooling air flow path inlet and the first hood vent fan assembly outlet.

9. A microwave oven hood vent combination appliance, comprising:
a cooking cavity;
an infrared module positioned above the cooking cavity and configured to emit infrared waves to detect a temperature of food within the cooking cavity; and
a hood vent fan assembly upward of the cooking cavity and including a hood vent fan assembly motor and a fan, wherein the fan delivers air along a ventilation air flow path through a ventilation air flow path inlet downward of the cooking cavity and out of a hood vent fan assembly outlet that is upward of the cooking cavity, and wherein the fan delivers air along a cooling air flow path through a cooling air flow path inlet upward of the cooking cavity, past the infrared module, such that heat from the infrared module is transferred to the air, past the hood vent fan assembly motor, and out of the hood vent fan assembly outlet.

10. The appliance of claim 9, wherein the fan is a centrifugal fan having a first inlet and a second inlet that is nearer than the first inlet to the hood vent fan assembly motor, wherein the centrifugal fan delivers air into the first inlet along the ventilation air flow path and the centrifugal fan delivers air into the second inlet along the cooling air flow path.

11. The appliance of claim 9, further comprising:
a base plate positioned above the cooking cavity and having an underside that faces generally downward and an upper side opposite the underside, wherein air delivered along the cooling air flow path travels through the cooling air flow path inlet, past the infrared module, beneath a portion of the underside, generally upward through an aperture defined by the base plate, past the hood vent fan assembly motor, and out of the hood vent fan assembly outlet.

12. The appliance of claim 11, further comprising:
a shell having an interior surface that defines the cooking cavity and an exterior surface opposite the interior surface, wherein a portion of the cooling air flow path is defined by the exterior surface of the shell and the base plate.

13. The appliance of claim 11, further comprising:
a vent grid assembly that includes a vent grid assembly shutter positioned upward of the cooking cavity and movable between an open position, wherein the cooling air flow path inlet is revealed, and a closed position.

14. The appliance of claim 13, wherein the vent grid assembly further comprises:
a vent grid assembly motor mounted to the upper side of the base plate and configured to drive movement of the vent grid assembly shutter between the open and closed positions.

15. The appliance of claim 9, wherein the infrared module is positioned lower than the cooling air flow path inlet and the hood vent fan assembly outlet.

16. A microwave oven hood vent combination appliance, comprising:
a cooking cavity;
an infrared module proximate to the cooking cavity and configured to emit infrared waves to detect a temperature of food within the cooking cavity; and
a hood vent fan assembly upward of the cooking cavity and including a hood vent fan assembly motor and a fan, wherein the fan delivers air along a cooling air flow path by drawing air into a cooling air flow path inlet upward of the cooking cavity and past the infrared module such that heat from the infrared module is transferred to the air, and expelling the air out of a hood vent fan assembly outlet.

17. The appliance of claim 16, wherein the fan delivers air along a ventilation air flow path through a ventilation air flow path inlet downward of the cooking cavity and out of the hood vent fan assembly outlet that is upward of the cooking cavity.

18. The appliance of claim 17, wherein the fan is a centrifugal fan having a first inlet and a second inlet that is nearer than the first inlet to the hood vent fan assembly motor, wherein the centrifugal fan delivers air into the first inlet along the ventilation air flow path and the centrifugal fan delivers air into the second inlet along the cooling air flow path.

19. The appliance of claim 16, further comprising:
a base plate positioned above the cooking cavity and having an underside that faces generally downward and an upper side opposite the underside, wherein air delivered along the cooling air flow path travels through the cooling air flow path inlet, past the infrared module, beneath a portion of the underside, generally upward through an aperture defined by the base plate, past the hood vent fan assembly motor, and out of the hood vent fan assembly outlet.

20. The appliance of claim 19, further comprising:
a shell having an interior surface that defines the cooking cavity and an exterior surface opposite the interior surface, wherein a portion of the cooling air flow path is defined by the exterior surface of the shell and the base plate.
